(19) United States
(12) Patent Application Publication
(10) Pub. No.: US 2026/0142082 A1
(43) Pub. Date: May 21, 2026

(54) MULTILAYER ELECTRONIC COMPONENT

(71) Applicant: SAMSUNG ELECTRO-MECHANICS CO., LTD., Suwon-si (KR)

(72) Inventors: Yong PARK, Suwon-si (KR); Kwan Soo PARK, Suwon-si (KR); Jong Ho LEE, Suwon-si (KR); Min Woo KIM, Suwon-si (KR); Jin Ho CHOI, Suwon-si (KR)

(73) Assignee: SAMSUNG ELECTRO-MECHANICS CO., LTD., Suwon-si (KR)

(21) Appl. No.: 19/308,698

(22) Filed: Aug. 25, 2025

(30) Foreign Application Priority Data
Nov. 15, 2024 (KR) 10-2024-0163277
Mar. 25, 2025 (KR) 10-2025-0038170

(51) Int. Cl. H01G 4/012; H01G 4/12; H01G 4/232; H01G 4/30

(52) U.S. Cl. CPC H01G 4/012; H01G 4/1209; H01G 4/232; H01G 4/30

(57) ABSTRACT

A multilayer electronic component according to an embodiment of the present disclosure includes a body including a dielectric layer and an internal electrode alternately disposed with the dielectric layer in a thickness direction; external electrodes disposed on the body; and a side margin portion disposed on the body, wherein side margin portion include a first margin layer disposed to contact the body, and a second margin layer disposed on the first margin layer, and wherein the first and second margin layers are different in terms of at least one of an average size in grains or a dielectric composition.

### CROSS-REFERENCE TO RELATED APPLICATION(S)

This application claims the benefit of priority to Korean Patent Application No. 10-2024-0163277 filed on Nov. 15, 2024 and Korean Patent Application No. 10-2025-0038170 filed on Mar. 25, 2025 in the Korean Intellectual Property Office, the disclosures of which are incorporated herein by reference in its entirety.

### TECHNICAL FIELD

The present disclosure relates to a multilayer electronic component.

### BACKGROUND

A multilayer ceramic capacitor (MLCC), a multilayer electronic component, may be a chip condenser mounted on the printed circuit boards of various types of electronic products, such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and is easily mounted. As various electronic devices such as computers, mobile devices, or the like have been miniaturized and implemented with high-output, demand for miniaturization and high capacitance of the multilayer ceramic capacitors has increased.

In order to miniaturize and increase capacitance of multilayer ceramic capacitors, maximization of an effective electrode area (increasing an effective volume fraction required for capacitance implementation) is required. In order to implement a small-sized and high-capacitance multilayer ceramic capacitor, when manufacturing the multilayer ceramic capacitor, an internal electrode may be manufactured to be exposed in a width direction of a body, thereby maximizing an area of the internal electrode in the width direction through a margin-less design. At this time, a method of blocking exposure to the outside by separately attaching a ceramic green sheet for a side margin portion to an exposed surface of the internal electrode in the width direction and then sintering the same may be applied.

As the side margin portion is formed by separately attaching the ceramic green sheet for side margin portion, capacitance per unit volume of the capacitor may be improved, but problems such as shortening of a lifespan of a chip, occurrence of defects, or the like may occur due to external moisture infiltration, plating solution infiltration during the plating process, or the like through an interface joining portion between the body and the side margin portion.

### SUMMARY

One of various problems to be solved by the present disclosure is to provide a multilayer electronic component having excellent moisture resistance reliability.

One of various problems to be solved by the present disclosure is to provide a multilayer electronic component having reduced pores.

One of various problems to be solved by the present disclosure is to provide a multilayer electronic component having excellent toughness and bending crack resistance.

Various problems to be solved by the present disclosure are not limited to the above-described contents, and will be more easily understood in the process of explaining specific embodiments of the present disclosure.

A multilayer electronic component according to an embodiment of the present disclosure includes a body including a dielectric layer and an internal electrode alternately disposed with the dielectric layer in a thickness direction, and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction; first and second external electrodes disposed on the third and fourth surfaces, respectively; a first side margin portion disposed on the fifth surface and extending to a portion of the first surface and a portion of the second surface; and a second side margin portion disposed on the sixth surface and extending to a portion of the first surface and a portion of the second surface, wherein the first and second side margin portions include a first margin layer disposed to contact the body, and a second margin layer disposed on the first margin layer, and wherein the first and second margin layers are different in terms of at least one of an average size in grains or a dielectric composition.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates a perspective view of the multilayer electronic component of FIG. 1 from which an external electrode is excluded.

FIG. 3 schematically illustrates a perspective view of the multilayer electronic component of FIG. 1 from which an external electrode and a side margin portion are excluded.

FIG. 4 schematically illustrates a cross-sectional view taken along line I-I′ of FIG. 1.

FIG. 5 schematically illustrates a plan view of FIG. 2.

FIG. 6 schematically illustrates a side view of FIG. 2.

FIG. 7 schematically illustrates a cross-sectional view taken along line II-II′ of FIG. 1.

FIG. 8 schematically illustrates an enlarged view of region M of FIG. 7.

FIG. 9A is an image of a portion of a first side margin portion of an embodiment taken through a scanning electron microscope (SEM), FIG. 9B is an image of a portion of a second side margin portion of the same embodiment taken through a scanning electron microscope (SEM), and FIG. 9C is an image of a portion of another second side margin portion of the same embodiment taken through a scanning electron microscope (SEM).

FIG. 10A is an image of grains included in first and second margin layers of a second side margin portion of an embodiment taken through a scanning electron microscope (SEM), and FIG. 10B is an image of grains distinguished through a program in the image of FIG. 10A.

FIG. 11A illustrates a thickness of each region of a first electrode layer of a comparative example as a color palette, and illustrates a percentage of each thickness as a histogram, and FIG. 11B illustrates a thickness of each region of a first electrode layer of an inventive example as a color palette, and illustrates a percentage of each thickness as a histogram.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawings, a Z-direction may be defined as a thickness direction or a first direction, an X-direction may be defined as a length direction or a second direction, and a Y direction may be defined as a width direction or a third direction.

In addition, a stack direction may be the thickness direction or the width direction.

### Multilayer Electronic Component

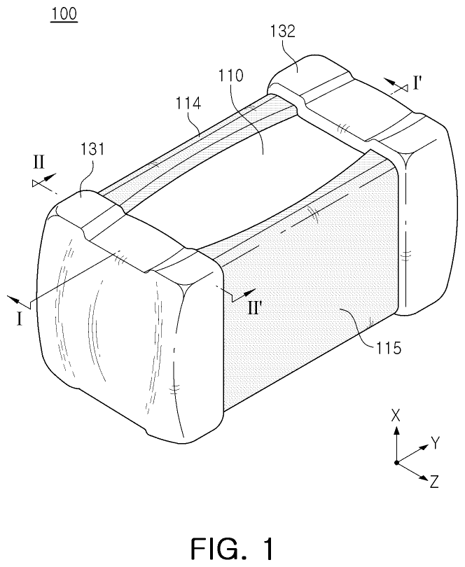

FIG. 1 schematically illustrates a perspective view of a multilayer electronic component according to an embodiment of the present disclosure.

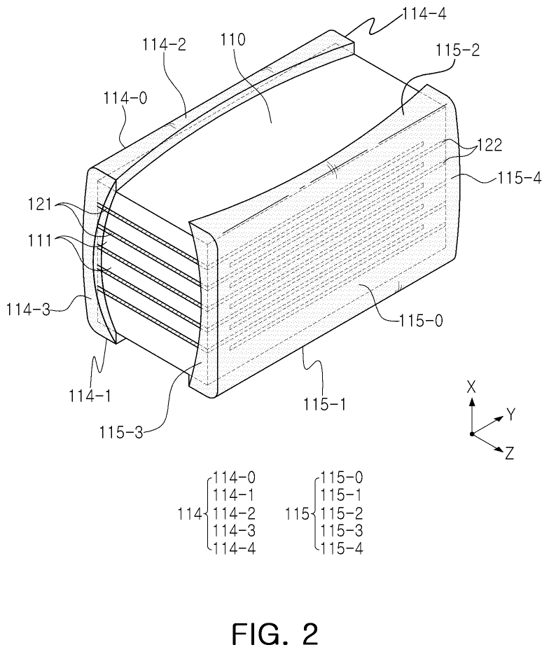

FIG. 2 schematically illustrates a perspective view of the multilayer electronic component of FIG. 1 from which an external electrode is excluded.

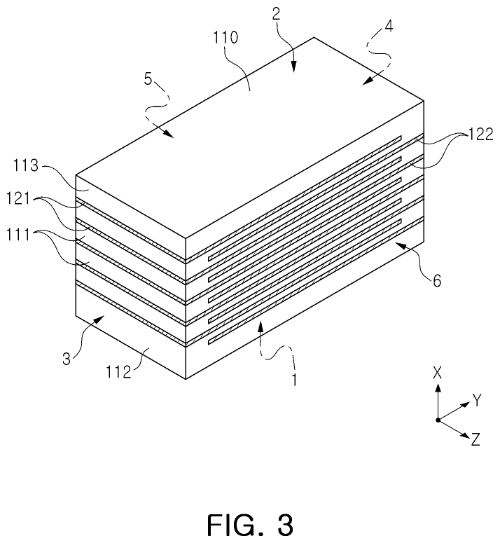

FIG. 3 schematically illustrates a perspective view of the multilayer electronic component of FIG. 1 from which an external electrode and a side margin portion are excluded.

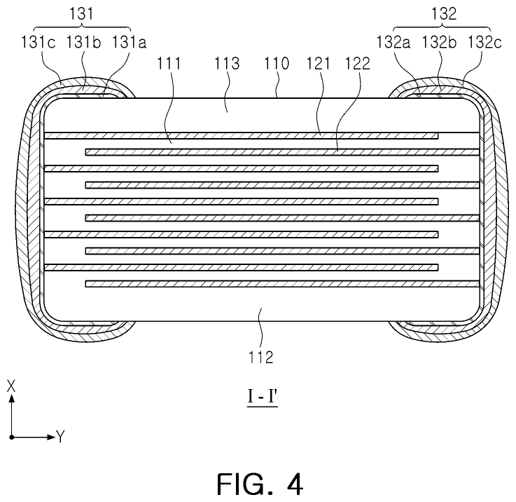

FIG. 4 schematically illustrates a cross-sectional view taken along line I-I′ of FIG. 1.

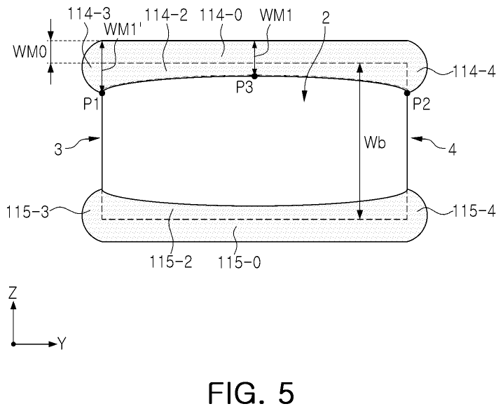

FIG. 5 schematically illustrates a plan view of FIG. 2.

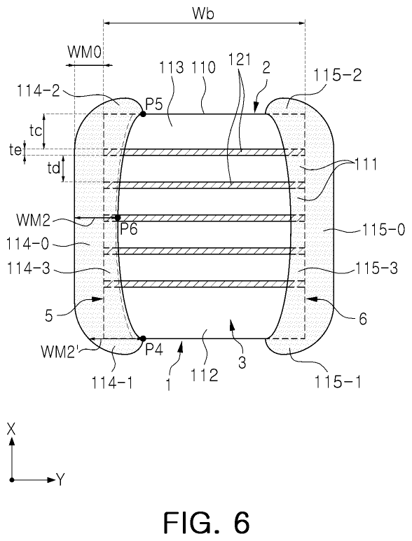

FIG. 6 schematically illustrates a side view of FIG. 2.

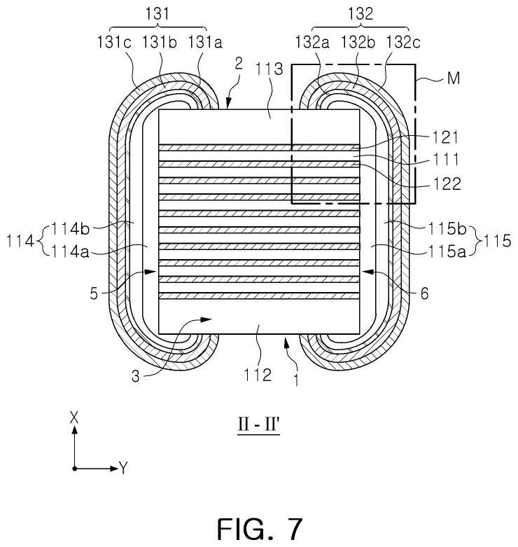

FIG. 7 schematically illustrates a cross-sectional view taken along line II-II′ of FIG. 1.

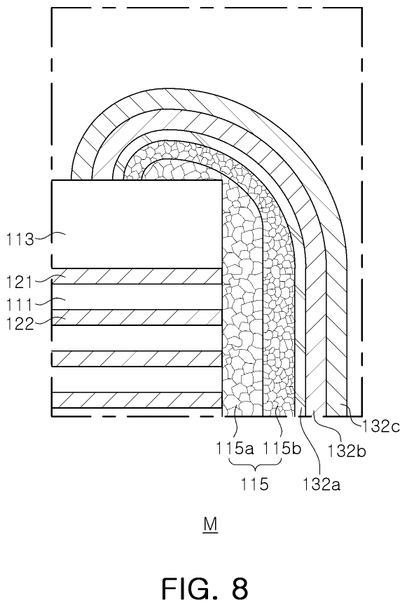

FIG. 8 schematically illustrates an enlarged view of region M of FIG. 7.

Hereinafter, with reference to FIGS. 1 to 8, a multilayer electronic component according to an embodiment of the present disclosure will be described in detail. However, a multilayer ceramic capacitor will be described as an example of a multilayer electronic component, but the present disclosure may also be applied to various electronic products utilizing a dielectric composition, such as an inductor, a piezoelectric element, a varistor, a thermistor, or the like.

A multilayer electronic component 100 according to an embodiment of the present disclosure may include a body 110 including a dielectric layer 111 and an internal electrode (121 and 122) alternately disposed with the dielectric layer 111 in the thickness direction, and including first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction; first and second external electrodes 131 and 132 disposed on the third and fourth surfaces 3 and 4, respectively; a first side margin portion 114 disposed on the fifth surface 5 and extending to a portion of the first surface 1 and a portion of the second surface 2; and a second side margin portion 115 disposed on the sixth surface 6 and extending to a portion of the first surface 1 and a portion of the second surface 2, wherein the first and second side margin portions 114 and 115 include a first margin layer (114a and 115a) disposed to contact the body 110, and a second margin layer (114b and 115b) disposed on the first margin layer (114a and 115a), and wherein the first and second margin layers (114a, 115a, 114b, and 115b) are different in terms of at least one of an average size in grains or a dielectric composition.

In the body 110, the dielectric layer 111 and the internal electrode (121 and 122) may be alternately stacked.

More specifically, the body 110 may include the capacitance formation portion Ac disposed in the body 110 and including a first internal electrode 121 and a second internal electrode 122, alternately disposed to oppose each other, with the dielectric layer 111 interposed therebetween, to form capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in the thickness direction, third and fourth surfaces 3 and 4 connected to the first and second surfaces 1 and 2 and opposing each other in the length direction, and fifth and sixth surfaces 5 and 6 connected to the first to fourth surfaces 1, 2, 3, and 4 and opposing each other in the width direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

A raw material for forming the dielectric layer 111 is not particularly limited, as long as sufficient capacitance may be obtained therewith. In general, a perovskite (ABO₃)-based material may be used, for example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃(0<x<1), Ba(Ti_{1-y}Ca_{y})O₃(0<y<1), (Ba₁₋ₓCaₓ)(Ti_{1-y}Zr_{y})O₃(0<x<1, 0<y<1), Ba(Ti_{1-y}Zr_{y})O₃(0<y<1), or the like, in which calcium (Ca), zirconium (Zr), or the like is partially dissolved in BaTiO₃, or the like.

In addition, various ceramic additives, organic solvents, binders, dispersants, or the like may be added to the powder of barium titanate (BaTiO₃), and the like, as the raw material for forming the dielectric layer 111, according to the purpose of the present disclosure.

To distinguish it from a dielectric layer included in a cover portion (112 and 113) and a side margin portion (114 and 115), which will be described later, a dielectric layer included in the capacitance formation portion Ac may be defined as a first dielectric layer, a dielectric layer included in the cover portion (112 and 113) may be defined as a second dielectric layer 111′ (not explicitly shown in the figures), and a dielectric layer included in the side margin portion (114 and 115) may be defined as a third dielectric layer.

In addition, the first to third dielectric layers may be formed using a dielectric material such as barium titanate (BaTiO₃), and may thus include a dielectric microstructure after sintering. The dielectric microstructure may include a plurality of grains, a grain boundary disposed between adjacent grains, and a triple point disposed at a point with which three or more grain boundaries are in contact, and may include a plurality of grains, a plurality of grain boundaries, and a plurality of triple points, respectively.

A thickness td of the dielectric layer 111 is not specifically limited.

To more easily achieve miniaturization and high capacitance of the multilayer electronic component, the thickness td of the dielectric layer 111 may be 1.5 μm or less, 1.2 μm or less, 1.0 μm or less, 0.8 μm or less, or 0.6 μm or less, and to achieve ultra-miniaturization, the thickness td of the dielectric layer 111 may be 0.5 μm or less, or 0.4 μm or less.

In this case, the thickness td of the dielectric layer 111 may mean a thickness td of the dielectric layer 111 disposed between the first and second internal electrodes 121 and 122.

In this case, the thickness td of the dielectric layer 111 may be a concept including a thickness td of one of the plurality of dielectric layers 111, or may be a concept including a thickness td of each of all the dielectric layers 111.

In addition, the thickness td of the dielectric layer 111 may mean an average thickness td of one dielectric layer 111, may mean an average thickness td of each of the plurality of dielectric layers 111, or may mean an average thickness td of the plurality of dielectric layers 111.

The average thickness td of the dielectric layer 111 may be measured by scanning images of a cross-section in the length and thickness direction of the body 110 using a scanning electron microscope (SEM) at 10,000× magnification. More specifically, the average thickness td of one dielectric layer 111 may mean an average value calculated by measuring thicknesses of one dielectric layer 111 at five (5) equally spaced points in the length direction in the scanned images. The five (5) equally spaced points may be designated in the capacitance formation portion Ac. In addition, when the average value measurement is extended to three dielectric layers 111 and the average value is measured, the average thickness td of the plurality of dielectric layers 111 may be further generalized.

The internal electrode (121 and 122) may be alternately stacked with the dielectric layer 111.

The internal electrode (121 and 122) may include a first internal electrode 121 and a second internal electrode 122, and the first and second internal electrodes 121 and 122 may be alternately disposed to oppose each other with the dielectric layer 111 forming the body 110 interposed therebetween, and may be exposed to third and fourth surfaces 3 and 4 of the body 110, respectively.

More specifically, the first internal electrode 121 may be spaced apart from the fourth surface 4, and may be exposed through the third surface 3, and the second internal electrode 122 may be spaced apart from the third surface 3 and exposed through the fourth surface 4. A first external electrode 131 may be disposed on the third surface 3 of the body 110, and may be connected to the first internal electrode 121, and a second external electrode 132 may be disposed on the fourth surface 4 of the body 110, and may be connected to the second internal electrode 122.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

The body 110 may be formed by alternately stacking and then sintering a first ceramic green sheet on which a paste for the first internal electrode, which will be the first internal electrode 121, is printed, and a second ceramic green sheet on which a paste for the second internal electrode, which will be the second internal electrode 122, is printed, and then sintering the sheets. A method of printing the conductive paste for the internal electrode may use a screen-printing method, a gravure printing method, or the like, and the present disclosure is not limited thereto.

A material forming the internal electrode (121 and 122) is not particularly limited, and a material having excellent electrical conductivity may be used. For example, the internal electrode (121 and 122) may include one or more of nickel (Ni), copper (Cu), palladium (Pd), silver (Ag), gold (Au), platinum (Pt), tin (Sn), tungsten (W), titanium (Ti), and alloys thereof.

A thickness te of the internal electrode (121 and 122) need not be specifically limited, and the description of the thickness te of the internal electrode (121 and 122) below may refer to a thickness te of each of the first internal electrode 121 and the second internal electrode 122.

To achieve miniaturization and high capacitance of the multilayer electronic component 100, the thickness te of the internal electrode (121 and 122) may be 1.5 μm or less, 1.2 μm or less, 1.0 μm or less, 0.8 μm or less, or 0.6 μm or less, and to achieve ultra-miniaturization, the thickness te of the internal electrode (121 and 122) may be 0.5 μm or less, or 0.4 μm or less.

In this case, the thickness te of the internal electrode (121 and 122) may be a concept including a thickness te of at least one of the plurality of internal electrodes (121 and 122), or may be a concept including a thickness te of all the internal electrode (121 and 122).

In addition, the thickness te of the internal electrode (121 and 122) may mean an average thickness te of one internal electrode (121 and 122), or may mean an average thickness te of each of the plurality of internal electrodes (121 and 122), or may mean an average thickness te of the plurality of internal electrodes (121 and 122).

The average thickness te of the internal electrode (121 and 122) may be measured by scanning images of a cross-section of the length and thickness direction of the body 110 using a scanning electron microscope (SEM) at 10,000× magnification. More specifically, the average thickness te of one internal electrode (121 and 122) may be an average value calculated by measuring thicknesses at five (5) equally spaced points in the length direction of one internal electrode in the scanned images. The five (5) equally spaced points may be designated in the capacitance formation portion Ac. In addition, when this average value measurement is extended to three internal electrodes (121 and 122) and an average value thereof is measured, an average thickness te of the plurality of internal electrodes (121 and 122) may be further generalized.

The body 110 may include a cover portion (112 and 113) disposed on both end-surfaces of the capacitance formation portion Ac in the thickness direction.

Specifically, the cover portion (112 and 113) may include a first cover portion 112 disposed on one surface of the capacitance formation portion Ac in the thickness direction, and a second cover portion 113 disposed on the other surface of the capacitance formation portion Ac in the thickness direction. More specifically, the cover portion (112 and 113) may include a first cover portion 112 disposed below the capacitance formation portion Ac in the thickness direction, and a second cover portion 113 disposed above the capacitance formation portion Ac in the thickness direction.

The first cover portion 112 and the second cover portion 113 may be formed by disposing or stacking a single second dielectric layer 111′ or two or more second dielectric layers 111′ on upper and lower surfaces of the capacitance formation portion Ac in the thickness direction, respectively, and may basically play a role in preventing damage to the internal electrode (121 and 122) due to physical or chemical stress.

The first cover portion 112 and the second cover portion 113 may not include the internal electrode (121 and 122), and may include the same dielectric material as the first dielectric layer 111 of the capacitance formation portion Ac. For example, the first cover portion 112 and the second cover portion 113 may include a dielectric material, and may include, for example, a dielectric material such as a barium titanate (BaTiO₃)-based dielectric material.

A thickness tc of the cover portion (112 and 113) does not need to be particularly limited, and the following description of the thickness tc of the cover portion (112 and 113) may mean a thickness tc of each of the first cover portion 112 and the second cover portion 113.

To more easily achieve miniaturization and high capacitance of the multilayer electronic component 100, the thickness tc of the cover portion (112 and 113) may be 100 μm or less or 50 μm or less, preferably 30 μm or less, and more preferably 20 μm or less in ultra-small products.

In this case, the thickness tc of the cover portion (112 and 113) may mean an average thickness of the cover portion (112 and 113).

In addition, the average thickness tc of the cover portion (112 and 113) may mean an average thickness tc of each of the first and second cover portions 112 and 113, or may mean an average thickness tc of the first and second cover portions 112 and 113.

The average thickness tc of the cover portion (112 and 113) may be measured by scanning images of a cross-section in the length and thickness directions of the body 110 with a scanning electron microscope (SEM) at 10,000× magnification. More specifically, the average thickness tc may mean an average value calculated by measuring thicknesses at five (5) equally spaced points in the length direction in scanned images of one cover portion (112 and 113).

In addition, the average thickness tc of the cover portion (112 and 113) measured by the above-described method may have a value substantially the same as the average thickness of the cover portion (112 and 113) in the cross-section in the width and thickness directions of the body 110.

The multilayer electronic component 100 may include a side margin portion (114 and 115) disposed on both end surfaces of the body 110 in the third direction.

More specifically, the side margin portion (114 and 115) may include a first side margin portion 114 disposed on the fifth surface 5 of the body 110, and a second side margin portion 115 disposed on the sixth surface 6 of the body 110.

A method of forming the side margin portion (114 and 115) may be as follows, but is not particularly limited thereto. First, a conductive paste may be applied to a ceramic green sheet applied to the capacitance formation portion Ac except for a portion in which the side margin portion (114 and 115) is to be formed, thereby forming and stacking the internal electrode (121 and 122). In this case, to suppress a step difference caused by the internal electrode (121 and 122), the internal electrode (121 and 122) after stacking may be cut to be exposed from the fifth and sixth surfaces 5 and 6 of the body 110, and then arranging or stacking a single dielectric layer or two or more dielectric layers in the third direction on the third-direction end-surface of the capacitance formation portion Ac.

The side margin portion (114 and 115) may basically play a role in preventing damage to the internal electrode (121 and 122) due to physical or chemical stress.

In addition, the side margin portion (114 and 115) may not include the internal electrode (121 and 122), and may include the same material as the first dielectric layer 111. For example, the first side margin portion 114 and the second side margin portion 115 may include a dielectric material, for example, a barium titanate (BaTiO₃)-based dielectric material.

More specifically, the side margin portion (114 and 115) may include a main component and an auxiliary component of a dielectric material (e.g., barium titanate (BaTiO₃)-based).

The auxiliary component included in the side margin portion (114 and 115) may include at least one of calcium (Ca), magnesium (Mg), silicon (Si), aluminum (Al), manganese (Mn), tin (Sn), zirconium (Zr), gallium (Ga), or phosphorus (P), but is not particularly limited thereto, and a specific content or amount of the auxiliary component will be described later.

In the present disclosure, the “main component” may mean a component occupying a relatively high weight ratio, a relatively high atomic number ratio, or a relatively high molar number ratio, as compared to other components, and a component occupying 50 wt % or more based on the weight of a component of a multilayer electronic component 100, for example, a dielectric layer 111, a component of 50 at % or more based on an atomic number, or a component of 50 mol % or more based on the molar number.

In addition, in the present disclosure, the “auxiliary component” may mean a component occupying a relatively low weight ratio, a relatively low atomic number ratio, or a relatively low molar number ratio, as compared to other components, and a component occupying less than 50 wt % based on the weight of a component of a multilayer electronic component 100, for example, a dielectric layer 111, a component of less than 50 at % based on an atomic number, or a component of less than 50 mol % based on the molar number.

In addition, in the present disclosure, as an example of a more specific method for measuring amounts of elements included in each configuration of the multilayer electronic component 100, components may be analyzed using an energy dispersive X-ray spectroscope (EDS) mode of a scanning electron microscope (SEM), an EDS mode of a transmission electron microscope (TEM), or an EDS mode of a scanning transmission electron microscope (STEM). First, a thinned analysis sample may be prepared using a focused ion beam (FIB) device in a region to be measured. The thinned sample may be subjected to Xe or Ar ion milling to remove a damage layer on a surface, and then each component to be measured may be mapped from images obtained using an SEM-EDS, a TEM-EDS, or an STEM-EDS to conduct a qualitative/quantitative analysis. In this case, a qualitative/quantitative analysis graph of each component may be expressed by converting the same into a mass percentage (wt %), an atomic percentage (at %), or a mole percentage (mol %) of each element, and may also be expressed by converting an amount of another specific component to an amount of a specific component.

In another method, a chip may be pulverized to select a region to be measured, and the selected region including the dielectric microstructure may be analyzed for the components of the region using a device such as an inductively coupled plasma optical emission spectrometer (ICP-OES), an inductively coupled plasma mass spectrometer (ICP-MS), or the like.

A thickness WM0 of the side margin portion (114 and 115) does not need to be specifically limited, and the following description of the thickness WM0 of the side margin portion (114 and 115) may mean a thickness WM0 of each of the first side margin portion 114 and the second side margin portion 115.

To more easily achieve miniaturization and high capacitance of the multilayer electronic component 100, an upper limit of the thickness WM0 of the side margin portion (114 and 115) may be 50 μm or less, preferably 40 μm or less, and a lower limit of the thickness WM0 may be 5 μm or more, preferably 10 μm or more.

In this case, the thickness of the side margin portion (114 and 115) may be a concept including a (average) thickness WM0 or a width direction (average) length WM0 of each of first and second main side margin portions 114-0 and 115-0 disposed on the fifth and sixth surfaces 5 and 6, but is not particularly limited thereto. The thickness of the side margin portion (114 and 115) may be a concept including a (average) thickness or a thickness direction (average) length of each of first extension portions (114-1, 114-2, 115-1, and 115-2) of the first and second side margin portions described below, and a (average) thickness or a thickness direction (average) length of each of second extension portions (114-3, 114-4, 115-3, and 115-4) of the first and second side margin portions described below. A detailed description of each region of the side margin portion (114 and 115) will be described later.

In this case, the thickness WM0 of the side margin portion (114 and 115) may mean an average thickness WM0 of the side margin portion (114 and 115).

In addition, the average thickness WM0 of the side margin portion (114 and 115) may mean an average thickness WM0 of each of the first and second side margin portions 114 and 115, or may mean an average thickness WM0 of the first and second side margin portions 114 and 115.

The average thickness WM0 of the side margin portion (114 and 115) may be measured by scanning images of a cross-section in the width and thickness direction of the body 110 using a scanning electron microscope (SEM) at 10,000× magnification. More specifically, it may mean the average value calculated by measuring the width direction length at five (5) equally spaced points in the thickness direction in the scanned images of one side margin portion (114 and 115).

To miniaturize and increase capacitance of multilayer ceramic capacitors, maximization of an effective electrode area (increasing an effective volume fraction required for capacitance implementation) is required. In order to implement a small-sized and high-capacitance multilayer ceramic capacitor, when manufacturing the multilayer ceramic capacitor, an internal electrode may be manufactured to be exposed in a width direction of a body, thereby maximizing an area of the internal electrode in the width direction through a margin-less design. In this case, a method of blocking exposure to the outside by separately attaching a ceramic green sheet for a side margin portion to an exposed surface of the internal electrode in the width direction and then sintering the same may be applied.

As the side margin portion is formed by separately attaching the ceramic green sheet for side margin portion, capacitance per unit volume of the capacitor may be improved, but problems such as shortening of a lifespan of a chip, occurrence of defects, or the like may occur due to external moisture infiltration, plating solution infiltration during the plating process, or the like through an interface joining portion between the body and the side margin portion.

The present disclosure may improve the above-described problem by blocking or distancing the penetration path of external moisture or plating solution that may penetrate through the interface joining portion formed at the boundary between the body and the side margin portion by forming the side margin portion to be extended longer than the conventional side margin portion to cover the body.

Therefore, in the multilayer electronic component 100 according to an embodiment of the present disclosure, the side margin portion (114 and 115) may include a first side margin portion 114 disposed on the fifth surface 5 and extends to portions of the first and second surfaces 1 and 2, and a second side margin portion 115 disposed on the sixth surface 6 and extends to portions of the first and second surfaces 1 and 2. Furthermore, the first side margin portion 114 may be disposed to extend to portions of the third and fourth surfaces 3 and 4, and the second side margin portion 115 may be disposed to extend to portions of the third and fourth surfaces 3 and 4. The specific structures of the first and second side margin portions 114 and 115 will be described later.

The first and second side margin portions 114 and 115 may include a first margin layer (114a and 115a) disposed to contact the body 110, and a second margin layer (114b and 115b) disposed on the first margin layer (114a and 115a).

The first margin layer (114a and 115a) and the second margin layer (114b and 115b) may be disposed on the fifth or sixth surface 5 and 6, and may be disposed to extend to portions of the first and second surfaces 1 and 2. Furthermore, the first margin layer (114a and 115a) and the second margin layer (114b and 115b) may be disposed to extend to portions of the third and fourth surfaces 3 and 4.

In the present disclosure, the first margin layer 114a of the first side margin portion may also be referred to as a 1-1 margin layer 114a, the first margin layer 115a of the second side margin portion may also be referred to as a 1-2 margin layer 115a, the second margin layer 114b of the first side margin portion may also be referred to as a 2-1 margin layer 114b, and the second margin layer 115b of the second side margin portion may also be referred to as a 2-2 margin layer 115b.

In addition, unless specifically contradictory in the present disclosure, it will be apparent to those skilled in the art that the description of the first margin layer (114a and 115a) may correspond to the description of the 1-1 margin layer 114a and the 1-2 margin layer 115a, the description of the second margin layer (114b and 115b) may correspond to the description of the 2-1 margin layer 114b and the 2-2 margin layer 115b, and vice versa.

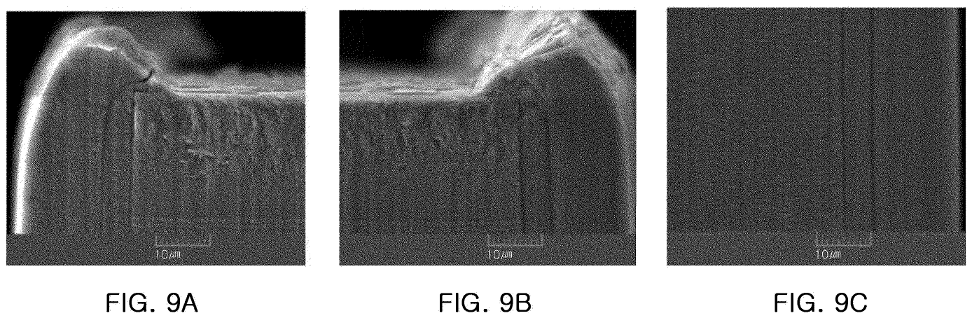

Referring to FIGS. 9A to 9C, the present disclosure can be more easily understood. FIG. 9A is an image of a portion of a first side margin portion of an embodiment taken through a scanning electron microscope (SEM), FIG. 9B is an image of a portion of a second side margin portion of the same embodiment taken through a scanning electron microscope (SEM), and FIG. 9C is an image of a portion of another second side margin portion of the same embodiment taken through a scanning electron microscope (SEM).

The 1-1 margin layer 114a may be disposed on the fifth surface 5, and may be disposed to extend to portions of the first and second surfaces 1 and 2, and may further be disposed to extend to portions of the third and fourth surfaces 3 and 4. The 2-1 margin layer 114b may be disposed on the 1-1 margin layer 114a, and more specifically, may be disposed on the 1-1 margin layer 114a disposed on the fifth surface 5, and the 1-1 margin layer 114a disposed to extend to portions of the first and second surfaces 1 and 2, and may further be disposed on the 1-1 margin layer 114a disposed to extend to portions of the third and fourth surfaces 3 and 4. In this case, it is preferable for the 2-1 margin layer 114b to be disposed to cover the 1-1 margin layer 114a to improve moisture resistance reliability, but it is not particularly limited thereto, and moisture resistance reliability may be improved as long as the 2-1 margin layer 114b may be disposed on the 1-1 margin layer 114a.

Likewise, the 1-2 margin layer 115a may be disposed on the sixth surface 6, and may extend to portions of the first and second surfaces 1 and 2, and may further be disposed to extend to portions of the third and fourth surfaces 3 and 4. The 2-2 margin layer 115b may be disposed on the 1-2 margin layer 115a, and more specifically, may be disposed on the 1-2 margin layer 115a disposed on the sixth surface 6 and the 1-2 margin layer 115a disposed to extend to portions of the first and second surfaces 1 and 2, and may further be disposed on the 1-2 margin layer 115a disposed to extend to portions of the third and fourth surfaces 3 and 4. In this case, it is preferable for the 2-2 margin layer 115b to be disposed to cover the 1-2 margin layer 115a to improve moisture resistance reliability, but is not particularly limited thereto, and moisture resistance reliability may be improved as long as the 2-2 margin layer 115b may be disposed on the 1-2 margin layer 115a.

The first margin layer (114a and 115a) and the second margin layer (114b and 115b) may be different in terms of at least one of an average size in grains or a dielectric composition, and the first and second margin layers (114a, 115a, 114b, and 115b) may have a boundary surface therebetween to be distinguished as different layers.

For example, the 1-1 margin layer 114a and the 2-1 margin layer 115a may be different in terms of at least one of an average size in grains or a dielectric composition, and a boundary surface to be distinguished as different layers from each other may be disposed therebetween. In addition, the 1-2 margin layer 115a and the 2-2 margin layer 115b may be different in terms of at least one of an average size in grains or a dielectric composition, and a boundary surface to be distinguished as different layers from each other may be disposed therebetween.

In this case, the “boundary surface to be distinguished” may mean that two layers are distinguished due to a physical difference, a chemical difference, and/or a simple optical difference, and although not particularly limited thereto, distinction between the layers may be distinguished by the presence or absence of a “boundary surface.” The boundary surface may mean a surface in which two layers contacting each other may be distinguishable from each other, and for example, may mean a state to be distinguishable by a difference in average size of the grains in equipment such as a scanning electron microscope (SEM) or the like (SEM, TEM, STEM) or the difference in the components through EDS analysis.

In this case, the “different in terms of an average size in grains” in the first margin layer (114a and 115a) and the second margin layer (114b and 115b) may mean that a difference in average size of the grains of the first margin layer (114a and 115a) and the second margin layer (114b and 115b) may be 25 μm or more, preferably 50 μm or more, and more preferably 100 μm or more.

The average size of the grains included in the first margin layer (114a and 115a) and the second margin layer (114b and 115b) may be obtained by the following method, but is not particularly limited thereto. First, the width and thickness direction cross-section of the side margin portion section may be imaged using a scanning electron microscope (SEM) or the like (SEM, TEM, STEM), and then the grains may be distinguished using an image analysis program or the like, and then the sizes of each grain may be obtained using a size analysis program, and then the average size of the grains may be obtained by averaging them. In this case, the image analysis program and/or the size analysis program may use a program built into a scanning electron microscope (SEM) or the like (SEM, TEM, STEM), but is not particularly limited thereto.

More specifically, for example, the size of the dielectric grain (Grain Size) may mean an arithmetic mean of a maximum Feret diameter and a minimum Feret diameter of the dielectric grain. The Feret diameter may be a distance between two parallel lines that completely include the dielectric grain when an outer surface of the dielectric grain is projected in a specific direction. Among Feret diameter values measured in all possible directions of the dielectric grain, the largest value may be the maximum Feret diameter, and the smallest value may be the minimum Feret diameter. In addition, an average size of 50 or more dielectric grains may be used as an average size of the dielectric grain.

The average sizes of the grains of the first margin layer (114a and 115a) and the second margin layer (114b and 115b) may be different.

Since the average sizes of the grains of the first margin layer (114a and 115a) and the second margin layer (114b and 115b) may be different, some regions of the first and second side margin portions 114 and 115 may have excellent moisture resistance reliability, and other regions may have excellent impact resistance, effectively protecting the capacitance formation portion Ac from external impact and improving crack occurrence due to mounting.

For example, in more details, if an average size of the grains of the first margin layer (114a and 115a) is Gs1 and an average size of the grains of the second margin layer (114b and 115b) is Gs2, the average size (Gs1) of the grains of the first margin layer (114a and 115a) may be larger than the average size (Gs2) of the grains of the second margin layer (114b and 115b) (Gs2<Gs1).

Since the average size (Gs1) of the grains of the first margin layer (114a and 115a) may be larger than the average size (Gs2) of the grains of the second margin layer (114b and 115b) (Gs2<Gs1), moisture resistance reliability of the first margin layer (114a and 115a) adjacent to the capacitance formation portion Ac may be improved, such that the internal electrode (121 and 122) may be effectively prevented from being shorted by external moisture penetration, and impact resistance of the second margin layer (114b and 115b) adjacent to the outside may be improved, such that the capacitance formation portion Ac may be effectively protected from external impact, and cracks caused by mounting may be improved.

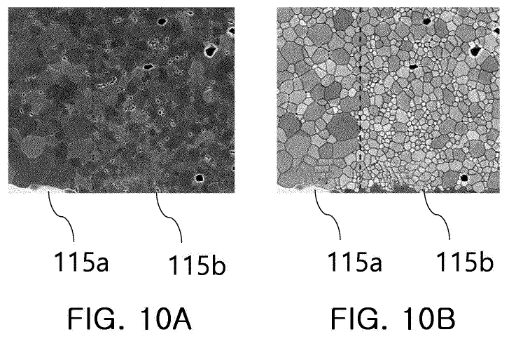

The present disclosure will be more easily understood with reference to FIGS. 10A and 10B. FIG. 10A is an image of grains in regions of the first margin layer 115a and the second margin layer 115b of the second side margin portion of an embodiment of the present disclosure, taken by a scanning electron microscope (SEM), and FIG. 10B is an image of grains distinguished by a program built into the scanning electron microscope (SEM) for FIG. 10A. Referring to FIGS. 10A and 10B, it can be seen that the average sizes of the grains in the first margin layer 115a and the second margin layer 115b of the second side margin portion may be different.

In this case, the average size (Gs1) of the grains in the first margin layer (114a and 115a) may satisfy 200 μm≤Gs1≤300 μm, but is not particularly limited thereto.

Since the average size (Gs1) of the grains of the first margin layer (114a and 115a) satisfies 200 μm≤Gs1≤300 μm, densification of the first margin layer (114a and 115a) may be excellent and pores may be small, such that moisture resistance reliability may be excellent.

When the average size (Gs1) of the grains of the first margin layer (114a and 115a) exceeds 300 μm (300 μm<Gs1), it may be difficult to control uniform grain growth, such that there may be a concern that DC capacitance is not excellent. When the average size (Gs1) of the grains of the first margin layer (114a and 115a) is less than 200 μm (Gs1<200 μm), sufficient grain growth may not occur, such that densification may be insufficient, and there may be a concern that moisture resistance reliability may not be excellent because there may be many pores.

The average size (Gs2) of the grains of the second margin layer (114b and 115b) may satisfy 75 μm≤Gs2≤175 μm, but is not particularly limited thereto.

Since the average size (Gs2) of the grains of the second margin layer (114b and 115b) satisfies 75 μm≤Gs2≤175 μm, a grain size of the second margin layer (114b and 115b) may be small, thereby improving impact resistance.

When the average size (Gs2) of the grains of the second margin layer (114b and 115b) exceeds 175 μm (175 μm<Gs2), there may be a concern that impact resistance may be reduced. When the average size (Gs2) of the grains of the second margin layer (114b and 115b) is less than 75 μm (Gs2<75 μm), there may be a concern that grain growth may be excessively suppressed and sintering may not proceed sufficiently.

In addition, dielectric compositions of the first margin layer (114a and 115a) and the second margin layer (114b and 115b) may be different.

In this case, the “different in terms of a dielectric composition” in the first margin layer (114a and 115a) and the second margin layer (114b and 115b) may mean that at least one of the main component or the auxiliary component may include different elements. Even though the same element is included, it may mean that an average mole number of a specific element based on 100 moles of titanium (Ti) may be different, and more specifically, it may mean that a difference in the average mole number of a specific element based on 100 moles of titanium (Ti) may be 0.5 mol or more.

As described above, the side margin portion (114 and 115) may include a main component and an auxiliary component of a dielectric material. The first margin layer (114a and 115a) and the second margin layer (114b and 115b) may also include a main component and an auxiliary component of a dielectric material, and the first margin layer (114a and 115a) and the second margin layer (114b and 115b) may have different dielectric compositions.

In addition, unless there may be special circumstances below, a mole number of a specific element may mean an average mole number of a specific element, and may mean a mole number based on 100 moles of titanium (Ti).

More specifically, for example, if an average mole number of gallium (Ga) relative to 100 moles of titanium (Ti) in the first margin layer (114a and 115a) is Ga1, and an average mole number of gallium (Ga) relative to 100 moles of titanium (Ti) in the second margin layer (114b and 115b) is Ga2, Ga2<Ga1 may be satisfied.

Specifically, the first margin layer (114a and 115a) may include gallium (Ga), and preferably includes gallium (Ga) in an amount of 1 mole or less (Ga1≤1 mole). The second margin layer (114b and 115b) may not include gallium (Ga) (Ga2=0), but is not particularly limited thereto, and may include gallium (Ga) (0≤Ga2<Ga1).

Gallium (Ga) may be a low-temperature sintering agent, may suppress formation of pores by inducing densification of a dielectric microstructure before grain growth of grains is completed, and may prevent breakdown voltage (BDV) from decreasing due to an electric field concentration phenomenon, or may play a role in improving moisture resistance reliability by blocking a moisture penetration path.

By satisfying Ga2<Ga1, grain growth and densification of the first margin layer (114a and 115a) may be improved, and a grain size may be controlled to suppress formation of pores, thereby improving moisture resistance reliability. For example, the first margin layer (114a and 115a) may have a lower porosity, a higher density, and a larger average size of the grains, as compared to the second margin layer (114b and 115b).

For another example, if an average mole number of phosphorus (P) relative to 100 moles of titanium (Ti) of the first margin layer (114a and 115a) is P1, and an average mole number of phosphorus (P) relative to 100 moles of titanium (Ti) of the second margin layer (114b and 115b) is P2, P2<P1 may be satisfied.

Specifically, the first margin layer (114a and 115a) may include phosphorus (P), and preferably includes phosphorus (P) in an amount of 1 mole or less (P1≤1 mole). The second margin layer (114b and 115b) may not include phosphorus (P) (P2=0), but is not particularly limited thereto, and may include phosphorus (P) (0≤P2<P1).

Phosphorus (P) may be a low-temperature sintering agent like gallium (Ga), and may contribute to forming uniformly sized grains. In addition, densification of a dielectric microstructure may be induced before grain growth of the grains is completed, thereby suppressing formation of pores, and breakdown voltage (BDV) may be prevented from being reduced due to an electric field concentration phenomenon, or moisture resistance reliability may be improved by blocking a moisture penetration path.

By satisfying P2<P1, grain growth and densification of the first margin layer (114a and 115a) may be improved, and a grain size may be controlled to suppress formation of pores, thereby improving moisture resistance reliability. For example, the first margin layer (114a and 115a) may have a lower porosity, a higher density, and a larger average size of the grains, as compared to the second margin layer (114b and 115b).

For another example, if an average mole number of zirconium (Zr) relative to 100 moles of titanium (Ti) of the first margin layer (114a and 115a) is Zr1, and an average mole number of zirconium (Zr) relative to 100 moles of titanium (Ti) of the second margin layer (114b and 115b) is Zr2, Zr1<Zr2 may be satisfied.

Specifically, the second margin layer (114b and 115b) may include zirconium (Zr), and preferably includes zirconium (Zr) in an amount of 1 mole or less (Zr2≤1 mole). The first margin layer (114a and 115a) may not include zirconium (Zr) (Zr1=0), but is not particularly limited thereto, and may include zirconium (Zr) (0≤Zr1<Zr2).

Zirconium (Zr) may play a role in suppressing grain growth. In addition, zirconium (Zr) may improve mechanical strength of the main component by relieving internal stress when entering a crystal lattice of the main component dielectric material (e.g., BaTiO₃), and may improve toughness.

By satisfying Zr1<Zr2, grain growth of the second margin layer (114b and 115b) may be suppressed, thereby controlling a grain size, and improving impact resistance and toughness. For example, the second margin layer (114b and 115b) may have superior mechanical strength including toughness, as compared to the first margin layer (114a and 115a), or the average size of the grains may be smaller.

An average thickness of the first margin layer (114a and 115a) of each of the first and second side margin portions 114 and 115 may be 1 μm or more and 5 μm or less, and an average thickness of the second margin layer (114b and 115b) of each of the first and second side margin portions 114 and 115 may be 9 μm or more and 35 μm or less.

By satisfying the average thickness of the first margin layer (114a and 115a) to be 1 μm or more and 5 μm or less, moisture resistance reliability may be sufficiently improved, and by satisfying the average thickness of the second margin layer (114b and 115b) to be 9 μm or more and 35 μm or less, impact resistance may be sufficiently improved.

When the average thickness of the first margin layer (114a and 115a) exceeds 5 μm, it may be difficult to achieve miniaturization of the multilayer electronic component 100, and when the average thickness of the first margin layer (114a and 115a) is less than 1 μm, there may be a concern that moisture resistance reliability may not be sufficiently improved.

When the average thickness of the second margin layer (114b and 115b) exceeds 35 μm, it may be difficult to achieve miniaturization of the multilayer electronic component 100, and when the average thickness of the second margin layer (114b and 115b) is less than 9 μm, impact resistance may not be sufficiently improved, and there may be a concern that cracks may occur due to external impact or the like.

Hereinafter, a structure of the side margin portion (114 and 115) will be described in more detail.

The side margin portion (114 and 115) may include a main side margin portion (114-0 and 115-0) disposed on the fifth and sixth surfaces 5 and 6, and a first extension portion (114-1, 114-2, 115-1, and 115-2) disposed to extend to portions of the first and second surfaces 1 and 2. In addition, in the present disclosure, the first and second side margin portions 114 and 115 may be spaced apart from each other.

The side margin portion (114 and 115) may include first extension portions (114-1, 114-2, 115-1, and 115-2) disposed to extend to portions of the first and second surfaces 1 and 2 of the body, to effectively prevent penetration of external moisture or plating solution, thereby improving moisture resistance reliability.

More specifically, the first side margin portion 114 may include a first main side margin portion 114-0 disposed on the fifth surface 5 and a first extension portion (114-1 and 114-2) disposed to extend to portions of the first and second surfaces 1 and 2. The first extension portion (114-1 and 114-2) of the first side margin portion may include a 1-1 extension portion 114-1 disposed to extend to a portion of the first surface 1 and a 1-2 extension portion 114-2 disposed to extend to a portion of the second surface 2.

The second side margin portion 115 may include a second main side margin portion 115-0 disposed on the sixth surface 6, and a first extension portion (115-1 and 115-2) disposed to extend to portions of the first and second surfaces 1 and 2. The first extension portion (115-1 and 115-2) of the second side margin portion may include a 1-1 extension portion 115-1 disposed to extend to a portion of the first surface 1, and a 1-2 extension portion 115-2 disposed to extend to a portion of the second surface 2.

Unless otherwise specified in the present disclosure, the description of the first extension portion (114-1, 114-2, 115-1, and 115-2) of the first and second side margin portions may be equally applied to the first extension portion (114-1 and 114-2) of the first side margin portion and the first extension portion (115-1 and 115-2) of the second side margin portion. In addition, the description regarding the first extension portion (114-1 and 114-2) of the first side margin portion may be equally applied to the 1-1 extension portion 114-1 and the 1-2 extension portion 114-2, and the description regarding the first extension portion (115-1 and 115-2) of the second side margin portion may be equally applied to the 1-1 extension portion 115-1 and the 1-2 extension portion 115-2.

At least some regions of the first extension portion (114-1, 114-2, 115-1, and 115-2) may have curvature, for example, may include a substantially curved region or a substantially concave region. In this case, the substantially curved region or substantially concave region may not mean a perfect curve, but may include a concept including a shape close to a curve.

The first side margin portion 114 disposed on some of the first and second surfaces 1 and 2 may include a substantially concave region toward the fifth surface 5, and the second side margin portion 115 disposed on some of the first and second surfaces 1 and 2 may include a substantially concave region toward the sixth surface 6.

For example, the first extension portion (114-1 and 114-2) of the first side margin portion may include a substantially concave region toward the fifth surface 5, and the first extension portion (115-1 and 115-2) of the second side margin portion may include a substantially concave region toward the sixth surface 6.

In this case, a radius of curvature R1 of the substantially concave region of the first extension portion (114-1, 114-2, 115-1, and 115-2) may satisfy 500 μm≤R1≤700 μm. For example, curvature κ1 of the substantially concave region of the first extension portion (114-1 and 114-2) of the first side margin portion and the first extension portion (115-1 and 115-2) of the second side margin portion may satisfy 1.4 mm⁻¹≤κ1≤2.0 mm⁻¹. In this case, the curvature κ1 may be the reciprocal of the radius of curvature R1 (κ1=1/R1).

Since the radius of curvature R1 of the substantially concave region of the first extension portion (114-1, 114-2, 115-1, and 115-2) satisfies 500 μm≤R1≤700 μm, an interface between the body 110 and the first and second main side margin portion (114-0 and 115-0) may be sufficiently covered, thereby increasing an external moisture penetration path and improving moisture resistance reliability.

In R1<500 μm, there may be a concern that a burr defect occurs in which the first extension portion (114-1, 114-2, 115-1, and 115-2) protrudes from the body 110 and stretches, and in R1<700 μm, there may be a concern that the interface between the body 110 and the first and second main side margin portion (114-0 and 115-0) may be exposed to the outside, thereby lowering moisture resistance reliability.

A method for measuring the radius of curvature R1 or the curvature κ1 of the first extension portion (114-1, 114-2, 115-1, and 115-2) may be as follows. The 1-2 extension portion 114-2 of the first side margin portion will be described as an example, but it will be obvious to those skilled in the art that the same may be applied to the 1-1 extension portion 114-1 of the first side margin portion, and the 1-1 extension portion 115-1 and the 1-2 extension portion 115-2 of the second side margin portion.

First, based on a plan view (e.g., direction facing the second surface 2) of the body 110 excluding the external electrode (131 and 132), a point P1 contacting an extension surface of the third surface 3 of the 1-2 extension portion 115-2 of the first side margin portion, and a point P2 contacting an extension surface of the fourth surface 4 may be marked, and then a midpoint P3 between P1 and P2 may be marked along a concave end line of the 1-2 extension portion 115-2 of the first side margin portion. In addition, assuming a virtual circle with the concave end line (dotted line) of P1-P3-P2 as a portion, a radius of the virtual circle may be obtained to obtain the radius of curvature R1. In addition, by taking the reciprocal of the radius of curvature R1, the curvature κ1 (=1/R1) may be obtained.

A width direction length of at least a portion of the first extension portion (114-1, 114-2, 115-1, and 115-2) may increase from a length direction central portion to both end portions.

For example, if a width direction length at the length direction central portion of the first extension portion (114-1, 114-2, 115-1, and 115-2) is WM1, and a width direction length at the length direction end portions of the first extension portion (114-1, 114-2, 115-1, and 115-2) is WM1′, WM1<WM1′ may be satisfied. In this case, WM1 may correspond to a minimum value among the width direction lengths of the first extension portion (114-1, 114-2, 115-1, and 115-2), and WM1′ may correspond to a maximum value among the width direction lengths of the first extension portion (114-1, 114-2, 115-1, and 115-2), but is not particularly limited thereto.

Since the first extension portion (114-1, 114-2, 115-1, and 115-2) satisfies WM1<WM1′, interfacial adhesion between the body 110 and the side margin portion (114 and 115) may be excellent, and in particular, moisture penetration in a corner portion of the body 110 in which external moisture penetration is easy or in an interface region between the body 110 and the first and second main side margin portion (114-0 and 115-0) may be further suppressed, such that moisture resistance reliability of the multilayer electronic component 100 may be further improved.

In a multilayer electronic component 100 according to an embodiment of the present disclosure, the first and second side margin portions 114 and 115 may include second extension portions (114-3, 114-4, 115-3, and 115-4) that may be disposed to extend to portions of the third and fourth surfaces 3 and 4.

The second extension portions (114-3, 114-4, 115-3, and 115-4) disposed to extend to portions of the third and fourth surfaces 3 and 4 of the body may be included to effectively prevent penetration of external moisture or plating solution, thereby improving moisture resistance reliability.

More specifically, the first side margin portion 114 may include a second extension portion (114-3 and 114-4) disposed to extend to portions of the third and fourth surfaces 3 and 4. The second extension portion (114-3 and 114-4) of the first side margin portion may include a 2-1 extension portion 114-3 disposed to extend to a portion of the third surface 3, and a 2-2 extension portion 114-4 disposed to extend to a portion of the fourth surface 4.

The second side margin portion 115 may include a second extension portion (115-3 and 115-4) disposed to extend to portions of the third and fourth surfaces 3 and 4. The second extension portion (115-3 and 115-4) of the second side margin portion may include a 2-1 extension portion 115-3 disposed to extend to a portion of the third surface 3, and a 2-2 extension portion 115-4 disposed to extend to a portion of the fourth surface 4.

Unless otherwise specified in the present disclosure, the description of the second extension portions (114-3, 114-4, 115-3, and 115-4) of the first and second side margin portions may be equally applied to the second extension portion (114-3 and 114-4) of the first side margin portion and the second extension portion (115-3 and 115-4) of the second side margin portion. In addition, the description regarding the second extension portion (114-3 and 114-4) of the first side margin portion may be equally applied to the 2-1 extension portion 114-3 and the 2-2 extension portion 114-4, and the description regarding the second extension portion (115-3 and 115-4) of the second side margin portion may be equally applied to the 2-1 extension portion 115-3 and the 2-2 extension portion 115-4.

At least some regions of the second extension portion (114-3, 114-4, 115-3, and 115-4) may have curvature, for example, may include a substantially curved region or a substantially concave region. In this case, the substantially curved region or substantially concave region may not mean a perfect curve, but may include a concept including a shape close to a curve.

The first side margin portions 114 disposed on some of the third and fourth surfaces 3 and 4 may include a substantially concave region toward the fifth surface 5, and the second side margin portions 115 disposed on some of the third and fourth surfaces 3 and 4 may include a substantially concave region toward the sixth surface 6.

For example, the second extension portion (114-3 and 114-4) of the first side margin portion may include a substantially concave region toward the fifth surface 5, and the second extension portion (115-3 and 115-4) of the second side margin portion may include a substantially concave region toward the sixth surface 6.

In this case, a radius of curvature R2 of the substantially concave region of the second extension portion (114-3, 114-4, 115-3, and 115-4) may satisfy 1000 μm≤R2≤1200 μm. For example, curvature κ2 of the substantially concave region of the second extension portion (114-3 and 114-4) of the first side margin portion and the second extension portion (115-3 and 115-4) of the second side margin portion may satisfy 0.8 mm⁻¹≤κ2≤1.0 mm⁻¹. In this case, the curvature κ2 may be the reciprocal of the radius of curvature R2 (κ2=1/R2).

Since the radius of curvature R2 of the substantially concave region of the second extension portion (114-3, 114-4, 115-3, and 115-4) satisfies 1000 μm≤R2≤1200 μm, an interface between the body 110 and the first and second main side margin portion (114-0 and 115-0) may be sufficiently covered, thereby increasing an external moisture penetration path and improving moisture resistance reliability.

In R2<1000 μm, there may be a concern that a burr defect occurs in which the second extension portion (114-3, 114-4, 115-3, and 115-4) protrudes from the body 110 and stretches, and in R2<1200 μm, there may be a concern that the interface between the body 110 and the first and second main side margin portion (114-0 and 115-0) may be exposed to the outside, thereby lowering moisture resistance reliability.

A method for measuring the radius of curvature R2 or the curvature κ2 of the second extension portion (114-3, 114-4, 115-3, and 115-4) may be as follows. The 2-1 extension portion 114-3 of the first side margin portion will be described as an example, but it will be obvious to those skilled in the art that the same may be applied to the 2-2 extension portion 114-4 of the first side margin portion, and the 2-1 extension portion 115-3 and the 2-2 extension portion 115-4 of the second side margin portion.

First, based on a side view (e.g., direction looking at the third side) of the body 110 excluding the external electrode (131 and 132), a point P4 contacting an extension surface of the first surface 1, and a point P5 contacting an extension surface of the second surface 2 among the 2-1 extension portion 115-3 of the first side margin portion may be marked, and then a midpoint P6 between P4 and P5 may be marked along a concave end line of the 2-1 extension portion 115-3 of the first side margin portion. In addition, assuming a virtual circle with the concave end line (dotted line) of P4-P6-P5 as a portion, a radius of the virtual circle may be obtained to obtain the radius of curvature R2. In addition, by taking the reciprocal of the radius of curvature R2, the curvature κ2 (=1/R2) may be obtained.

A width direction length of at least a portion of the second extension portion (114-3, 114-4, 115-3, and 115-4) may increase from a thickness direction central portion to both end portions.

For example, if a width direction length at the thickness direction central portion of the second extension portion (114-3, 114-4, 115-3, and 115-4) is WM2, and a width direction length at the thickness direction end portions of the second extension portion (114-3, 114-4, 115-3, and 115-4) is WM2′, WM2<WM2′ may be satisfied. In this case, WM2 may correspond to a minimum value among the width direction lengths of the second extension portion (114-3, 114-4, 115-3, and 115-4), and WM2′ may correspond to a maximum value among the width direction lengths of the second extension portion (114-3, 114-4, 115-3, and 115-4), but is not particularly limited thereto.

Since the second extension portion (114-3, 114-4, 115-3, and 115-4) satisfies WM2<WM2′, interfacial adhesion between the body 110 and the side margin portion (114 and 115) may be excellent, and in particular, moisture penetration in a corner portion of the body 110 in which external moisture penetration is easy or in an interface region between the body 110 and the first and second main side margin portion (114-0 and 115-0) may be further suppressed, such that moisture resistance reliability of the multilayer electronic component 100 may be further improved.

In an embodiment of the present disclosure, a structure in which the multilayer electronic component 100 has two external electrodes 131 and 132 is illustrated, but the number, shapes, or the like of the external electrode (131 and 132) may be changed depending on a shape of the internal electrode (121 and 122) or other purposes.

The external electrode (131 and 132) may be disposed on the body 110 and connected to the internal electrode (121 and 122).

More specifically, the external electrode (131 and 132) may include first and second external electrodes 131 and 132 disposed on the third and fourth surfaces 3 and 4 of the body 110, respectively, and connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and the second external electrode 132 may be disposed on portions of the first, second, fifth, and sixth surfaces 1, 2, 5, and 6 of the body 110.

The external electrode (131 and 132) may include a connection portion disposed on the third and fourth surfaces 3 and 4 of the body 110, and a band portion extended from the connection portion to portions of the first and second surfaces 1 and 2 of the body 110. In this case, the connection portion and the band portion may refer to regions corresponding thereto.

More specifically, the first external electrode 131 may include a first connection portion disposed on the third surface 3 of the body 110, and a first band portion extended from the first connection portion to portions of the first and second surfaces 1 and 2, and the second external electrode 132 may include a second connection portion disposed on the fourth surface 4 of the body 110, and a second band portion extended from the second connection portion to portions of the first and second surfaces 1 and 2.

The first band portion may include a 1-1 band portion extending from the first connection portion to a portion of the first surface 1, and a 1-2 band portion extending from the first connection portion to a portion of the second surface 2, and the second band portion may include a 2-1 band portion extending from the second connection portion to a portion of the first surface 1, and a 2-2 band portion extending from the second connection portion to a portion of the second surface 2.

In the present disclosure, unless specifically contradictory, the description of the band portion may correspond to the description of each of the first band portion and the second band portion, and may further correspond to the description of each of the 1-1 band portion, the 1-2 band portion, the 2-1 band portion, and the 2-2 band portion.

The external electrode (131 and 132) may be formed using a specific material that has electrical conductivity, such as a metal, and the specific material may be determined in consideration of electrical characteristics, structural stability, or the like, and may further have a multilayer structure.

For example, the external electrode (131 and 132) may include a first electrode layer (131a and 132a) disposed on the body 110, and a second electrode layer (131b and 132b) disposed on the first electrode layer (131a and 132a). Furthermore, the external electrode may include a third electrode layer (131c and 132c) disposed on the second electrode layer (131b and 132b).

In this case, it is preferable that the first to third electrode layers (131a, 132a, 131b, 132b, 131c, and 132c) correspond to distinct layers. However, it is not particularly limited thereto, and may be distinguished according to an order of manufacturing process, and at least two adjacent layers among the first to third electrode layers (131a, 132a, 131b, 132b, 131c, and 132c) may not be distinguished from each other, and may be observed as one layer.

In the present disclosure, “distinguished” may mean that two layers may be distinguished due to physical differences, chemical differences, and/or simple optical differences, and are not particularly limited thereto, but layers may be distinguished by the presence or absence of an “interface.” The interface may mean a surface on which two layers contacting each other are distinguishable from each other, and may mean a state in which the two layers may be distinguishable, for example, by differences in components through EDS analysis in equipment such as a scanning electron microscope (SEM) or the like.

The first electrode layer (131a and 132a) may be formed by transferring a sheet including a conductive metal onto the body 110, or may be formed by applying a conductive paste for an external electrode including a conductive metal to the body 110 and then sintering the same, or may be formed by dipping the body 110 into a conductive paste for an external electrode including a conductive metal, but are not particularly limited thereto.

For a more specific example of the first electrode layer (131a and 132a), the first electrode layer (131a and 132a) may be a sintered electrode including a conductive metal and glass.

A material having excellent electrical conductivity may be used as a conductive metal included in the first electrode layer (131a and 132a). For example, the conductive metal may include at least one selected from the group consisting of nickel (Ni), copper (Cu), palladium (Pd), silver (Ag), gold (Au), platinum (Pt), tin (Sn), tungsten (W), titanium (Ti), and alloys thereof, but is not particularly limited thereto.

In addition, glass included in the first electrode layer (131a and 132a) may play a role in improving joining with the body 110.

In an embodiment of the present disclosure, an average thickness of the first electrode layer (131a and 132a) may be 1 μm or more and 8 μm or less.

A method for measuring a thickness or an average thickness of the first electrode layer (131a and 132a) may be as follows, and it will be obvious to those skilled in the art that a thickness or an average thickness of the second electrode layer (131b and 132b) or the third electrode layer (131c and 132c) may be measured in the same manner. Hereinafter, a method for measuring a thickness or an average thickness of the first electrode layer 132a of the second external electrode will be described, but it will be obvious to those skilled in the art that the same method may be applied to a method for measuring a thickness or an average thickness of other electrode layers, including the first electrode layer 131a of the first external electrode.

First, thickness and width-direction cross-sections including the second cover portion 113, the second side margin portion 115, and the second external electrode 132 of the multilayer electronic component 100 may be photographed using a scanning electron microscope (SEM). In this case, in addition to a scanning electron microscope (SEM), a transmission electron microscope (TEM) or a scanning transmission electron microscope (STEM) may be used. In images captured by the scanning electron microscope (SEM), the first electrode layer 132a of the second external electrode covering the second cover portion 113 and the second side margin portion 115 may be observed and layer classification may be performed. In this case, when the second external electrode 132 is formed as a multilayer structure, a boundary surface of each layer may be distinguished, and when it is difficult to distinguish, layer classification is possible according to a main component material included in each layer using energy dispersive X-ray spectroscopy (EDS). Thereafter, thicknesses of the first electrode layer 132a of the second external electrode may be measured at 3,000 points and quantified using a program built into the scanning electron microscope (SEM). In addition, an average value of the thicknesses at 3,000 points measured by the above-described method may correspond to an average thickness of the first electrode layer 132a of the second external electrode.

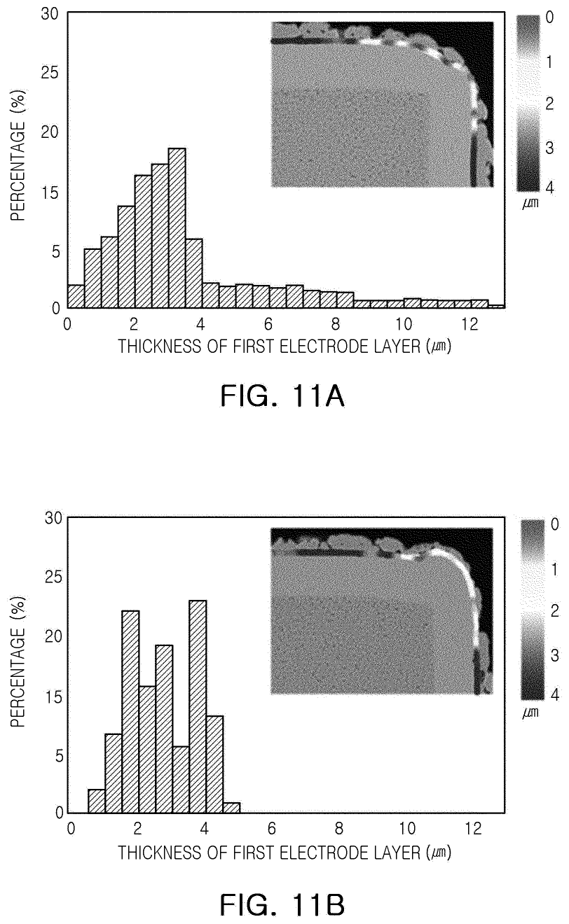

Referring to FIGS. 11A and 11B, the present disclosure can be more easily understood. FIG. 11A relates to a comparative example having a conventional second side margin portion structure (first side margin portion also has the same structure) not disposed to extend to the first and second surfaces of the body but disposed only on the sixth surface 6, and FIG. 11B relates to an inventive example of the present disclosure having a second side margin portion structure (first side margin portion also has the same structure) disposed on the sixth surface 6 of the body, and disposed to extend to the first and second surfaces. Thicknesses of the first electrode layer in the comparative example and the inventive example may be measured by the above-described method. For example, the thicknesses may be measured at 3,000 points as in FIGS. 11A and 11B, and the thickness at each measured location may be represented as a color palette in the image. In addition, the measured thickness may be divided into ranges of 0.5 μm, and may be represented as a histogram in which a sum of the percentages is 100%.

When an average thickness of the first electrode layer (131a and 132a) is 1 μm or more and 8 μm or less, it is possible to achieve (ultra) miniaturization of the multilayer electronic component 100 while achieving excellent electrical connectivity.

When an average thickness of the first electrode layer (131a and 132a) may be less than 1 μm, electrical connectivity may not be sufficient and a disconnected region of the first electrode layer (131a and 132a) may increase. When an average thickness of the first electrode layer (131a and 132a) exceeds 8 μm, it may be difficult to miniaturize the multilayer electronic component 100.

In the first electrode layer (131a and 132a), a region having a thickness of less than 1 μm may be less than 5%, preferably less than 2%.

When a region having a thickness of less than 1 μm in the first electrode layer (131a and 132a) is less than 5%, connectivity of the first electrode layer (131a and 132a) may be excellent, electrical connectivity may be improved, and miniaturization of the multilayer electronic component 100 may be achieved.

When a region having a thickness of less than 1 μm in the first electrode layer (131a and 132a) is 5% or more, a disconnected region of the first electrode layer (131a and 132a) may increase, and electrical connectivity may be insufficient.

In addition, a region having a thickness of 1 μm or more and 5 μm or less in the first electrode layer (131a and 132a) may be 95% or more, and preferably more than 98%.

When a region having a thickness of 1 μm or more and 5 μm or less in the first electrode layer (131a and 132a) is 95% or more, connectivity of the first electrode layer (131a and 132a) may be excellent, electrical connectivity may be improved, and miniaturization of the multilayer electronic component 100 may be achieved.

When a region having a thickness of 1 μm or more and 5 μm or less in the first electrode layer (131a and 132a) is less than 95%, electrical connectivity may not be sufficient or there may be a concern that a short circuit defect may occur, and miniaturization of the multilayer electronic component 100 may be difficult.

In the present disclosure, since the side margin portion (114 and 115) have a structure disposed to extend to at least a portion of the first to fourth surfaces 1, 2, 3, and 4, for example, including the first extension portion (114-1, 114-2, 115-1, and 115-2) or the second extension portion (114-3, 114-4, 115-3, and 115-4), a first electrode layer (131a and 132a) having a thin thickness and being uniform may be formed.

When an external electrode paste, for example, a paste to be a first electrode layer (131a and 132a), is formed on the body 110 and the side margin portion (114 and 115), the external electrode paste may suppress flow at the corner portion of the body 110 by forming a vortex by the first extension portion (114-1, 114-2, 115-1, and 115-2) or the second extension portion (114-3, 114-4, 115-3, and 115-4) of the side margin portion, thereby forming an external electrode having a thin and uniform thickness.

In a conventional side margin portion structure without first and second extension portions, in a corner portion of a body in which there is little curvature (when a radius of curvature is relatively small), flow of an external electrode paste may increase, making it difficult to form an external electrode having a constant thickness, such that almost no external electrode may be formed, and in a central region of the body in which the flow is relatively slow, the external electrode may be formed to be thick due to surface tension. In addition, in a conventional side margin portion structure without first and second extension portions, in a corner portion of a body in which there is curvature (when a radius of curvature is relatively large), flow of an external electrode paste may decrease, such that a thickness of the entire external electrode may be formed thinly, but may not be formed uniformly.

In addition, in an embodiment of the present disclosure, an average thickness of the first electrode layer (131a and 132a) may be thinner than an average thickness of the second electrode layer (131b and 132b) or the third electrode layer (131c and 132c) described below.

Since the average thickness of the first electrode layer (131a and 132a) may be thinner than the average thickness of the second electrode layer (131b and 132b) or the third electrode layer (131c and 132c), it is possible to achieve miniaturization of the multilayer electronic component 100 while achieving excellent electrical connectivity.

When the average thickness of the first electrode layer (131a and 132a) is thicker than the average thickness of the second electrode layer (131b and 132b) or the third electrode layer (131c and 132c), it may be difficult to miniaturize the multilayer electronic component 100.

The second electrode layer (131b and 132b) and the third electrode layer (131c and 132c) may play a role in improving mounting characteristics, and may be a plating layer formed on the first electrode layer (131a and 132a) by a plating method, but is not particularly limited thereto. Types of the second electrode layers (131b and 132b) and the third electrode layers (131c and 132c) are not particularly limited, and may include, for example, at least one of nickel (Ni), tin (Sn), silver (Ag), palladium (Pd), and alloys thereof.

A size of the multilayer electronic component 100 does not need to be particularly limited.

To achieve miniaturization and high capacitance at the same time, thicknesses of the dielectric layer and the internal electrode should be reduced to increase the number of layers. Therefore, an effect according to the present disclosure may be more remarkable in a multilayer electronic component 100 having a size of 2012 (length×width: 2.0 mm×1.2 mm, a length and a width satisfy an error of ±10% and the same applies hereinafter), 1005 (length×width: 1.0 mm×0.5 mm), a size of 0603 (length×width: 0.6 mm×0.3 mm), a size of 0402 (length×width: 0.4 mm×0.2 mm), or a size of 0201 (length×width: 0.2 mm×0.1 mm) or less.

In addition, the multilayer electronic component 100 may have a width greater than a length.

Hereinafter, a method for manufacturing the first and second side margin portions 114 and 115 including the first margin layer (114a and 115a) and the second margin layer (114b and 115b) will be described, but is not particularly limited thereto.

Except for the side margin portion (114 and 115), the present disclosure may be the same as the conventional manufacturing method. Therefore, descriptions thereof will be omitted.

In addition, a first margin portion green sheet to be the first side margin portion 114 will be described below, but it will be obvious to those skilled in the art that the same may be applied to a second margin portion green sheet unless there may be special circumstances.

In addition, a 1-1 margin layer green sheet may become the 1-1 margin layer of the first side margin portion, and a 2-1 margin layer green sheet may become the 2-1 margin layer of the first side margin portion.

First, a first process condition may be applied in a width direction of a green body on which a ceramic green sheet and an internal electrode pattern are stacked.

The first process condition may include at least one of a pressure condition of 0.1 ton or more and 1.2 ton or less and a temperature condition of 60° C. or more and 120° C. or less, and it is preferable to apply both the pressure condition and the temperature condition to the first process condition.

The 1-1 margin layer green sheet may be attached under the first process condition, to have a structure in which a margin green sheet extends on at least one of thickness direction surfaces 1 and 2 or length direction surfaces 3 and 4 of the green body. In this case, the margin green sheet disposed on the thickness direction surfaces may become the first extension portions (114-1 and 114-2), and the margin green sheet disposed on the length direction surfaces may become the second extension portions (114-3 and 114-4).

The 1-1 margin layer green sheet may be attached using a first heating and pressurizing member.

For example, the 1-1 margin layer green sheet may be provided between a 1-1 heating and pressurizing member and a 1-2 heating and pressurizing member, and the green body may be disposed thereon, and then the heating and pressurizing members may be pressed to attach the 1-1 margin layer green sheet to the green body.

In this case, when heating and pressure are applied to attach the 1-1 margin layer green sheet to the green body, the green body may be drawn in a direction of the first elastic member together with the 1-1 margin layer green sheet and a first elastic member, such that the 1-1 margin layer green sheet may be attached to other surfaces including a width direction surface of the green body and thickness direction two surfaces 1 and 2 and length direction two surfaces 3 and 4 of the green body.

The 1-1 heating and pressurizing member may include a first lower steel plate and a first elastic member disposed on an upper surface of the first lower steel plate, and the 1-2 heating and pressurizing member may include a first upper steel plate and a first adhesive sheet disposed on a lower surface of the first upper steel plate.

In this case, the first elastic member may include a soft elastomer.

In this case, the soft elastomer may preferably have an elastic modulus of more than 50 MPa, and more specifically, for example, may include at least one of a natural rubber, a neoprene rubber, a silicone rubber, polyurethane, an ethylene propylene diene monomer (EPDM), a styrene-butadiene rubber (SBR), polybutadiene, or a thermoplastic elastomer, but is not particularly limited thereto.

Next, a punching process may be performed on the green body to which a 1-1 margin layer green sheet is attached under a second process condition.

The second process condition may include at least one of a pressure condition of 5 tons or more and 12 tons or less and a temperature condition of 20° C. or more and 60° C. or less, and it is preferable to apply both the pressure condition and the temperature condition to the second process condition.

The punching process may be performed under the second process condition, a remaining 1-1 margin layer green sheet extended and left on at least one of the thickness direction surfaces and the length direction surfaces of the green body may be easily detached and removed.

The punching process may be performed using a second heating and pressurizing member.

For example, the green body to which a 1-1 margin layer green sheet s attached may be disposed between a 2-1 heating and pressurizing member and a 2-2 heating and pressurizing member, and then punched by pressing.

The 2-1 heating and pressurizing member may include a second lower steel plate and a second elastic member disposed on an upper surface of the second lower steel plate, and the 2-2 heating and pressurizing member may include a second upper steel plate and a second adhesive sheet disposed on a lower surface of the second upper steel plate.

In this case, the second elastic member may include an elastomer, and it is preferable to be an elastomer having a lower elastic coefficient than that of the first elastic member.

Thereafter, a 2-2 margin layer green sheet may be attached to the same width direction of the green body to which a 2-1 margin layer green sheet is attached under the first process condition described above, and a punching process may be performed on the 2-2 margin layer green sheet under the second process condition. In this case, an adhesive layer that may act as an adhesive may be disposed between the 1-1 margin layer green sheet and the 2-1 margin layer green sheet to prevent adhesion failure of the 1-1 margin layer green sheet and the 2-1 margin layer green sheet during a sintering process. The adhesive layer may be removed during the sintering process.

A method of attaching the 1-1 margin layer green sheet to the green body under the first process condition, performing the punching process on the 1-1 margin layer green sheet under the second process condition, attaching the 2-1 margin layer green sheet under the first process condition, and performing the punching process on the 2-1 margin layer green sheet under the second process condition has been described, but is not particularly limited thereto. For example, the 1-1 margin layer green sheet and the 2-1 margin layer green sheet may be attached to the green body together under the first process condition, and then the punching process may be performed on the 1-1 margin layer green sheet and the 2-1 margin layer green sheet together under the second process condition.

In addition, it will be obvious to those skilled in the art that the 1-2 margin layer green sheet and the 2-2 margin layer green sheet may be attached to the green body by the above-described method.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of various effects of the present disclosure is to improve moisture resistance reliability of a multilayer electronic component.

One of various effects of the present disclosure is to reduce pores in a multilayer electronic component.

One of various effects of the present disclosure is to improve toughness and bending crack resistance of a multilayer electronic component.

Various advantages and effects of the present disclosure are not limited to the above-described contents, and can be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a dielectric layer and an internal electrode alternately disposed with the dielectric layer in a thickness direction, and including first and second surfaces opposing each other in the thickness direction, third and fourth surfaces connected to the first and second surfaces and opposing each other in a length direction, and fifth and sixth surfaces connected to the first to fourth surfaces and opposing each other in a width direction;
first and second external electrodes disposed on the third and fourth surfaces, respectively;
a first side margin portion disposed on the fifth surface and extending to a portion of the first surface and a portion of the second surface; and
a second side margin portion disposed on the sixth surface and extending to a portion of the first surface and a portion of the second surface,
wherein the first and second side margin portions include a first margin layer disposed to contact the body, and a second margin layer disposed on the first margin layer, and
wherein the first and second margin layers are different in terms of at least one of an average size in grains or a dielectric composition.

2. The multilayer electronic component of claim 1, wherein the first and second side margin portions have a boundary surface to distinguish the first and second margin layers as different layers.

3. The multilayer electronic component of claim 1, satisfying Gs2<Gs1, where an average size of the grains in the first margin layer is Gs1, and an average size of the grains in the second margin layer is Gs2.

4. The multilayer electronic component of claim 3, satisfying 200 μm≤Gs1≤300 μm.

5. The multilayer electronic component of claim 3, satisfying 75 μm≤Gs2≤175 μm.

6. The multilayer electronic component of claim 1, satisfying Ga2<Ga1, where an average mole number of gallium (Ga) relative to 100 moles of titanium (Ti) in the first margin layer is Ga1, and an average mole number of gallium (Ga) relative to 100 moles of titanium (Ti) in the second margin layer is Ga2.

7. The multilayer electronic component of claim 1, satisfying P2<P1, where an average mole number of phosphorus (P) relative to 100 moles of titanium (Ti) in the first margin layer is P1, and an average mole number of phosphorus (P) relative to 100 moles of titanium (Ti) in the second margin layer is P2.

8. The multilayer electronic component of claim 1, satisfying Zr1<Zr2, where an average mole number of zirconium (Zr) relative to 100 moles of titanium (Ti) in the first margin layer is Zr1, and an average mole number of zirconium (Zr) relative to 100 moles of titanium (Ti) in the second margin layer is Zr2.

9. The multilayer electronic component of claim 1, wherein an average thickness of the first margin layer in each of the first and second side margin portions is 1 μm or more and 5 μm or less, and
an average thickness of the second margin layer in each of the first and second side margin portions is 9 μm or more and 35 μm or less.

10. The multilayer electronic component of claim 1, wherein the first side margin portion disposed on a portion of the first surface and a portion of the second surface includes a substantially concave region toward the fifth surface, and the second side margin portion disposed on a portion of the first surface and a portion of the second surface includes a substantially concave region toward the sixth surface.

11. The multilayer electronic component of claim 10, wherein a radius of curvature R1 of the substantially concave region of each of the first and second side margin portions disposed on the portion of the first surface and the portion of the second surface satisfies 500 μm≤R1≤700 μm.

12. The multilayer electronic component of claim 1, wherein the first and second side margin portions are disposed to extend to a portion of the third surface and a portion of the fourth surface.

13. The multilayer electronic component of claim 12, wherein the first side margin portion disposed on the portion of the third surface and the portion of the fourth surface includes a substantially concave region toward the fifth surface, and the second side margin portion disposed on the portion of the third surface and the portion of the fourth surface includes a substantially concave region toward the sixth surface.

14. The multilayer electronic component of claim 13, wherein a radius of curvature R2 of the substantially concave region of each of the first and second side margin portions disposed on the third and fourth surfaces satisfies 1000 μm≤R2≤1200 μm.

15. The multilayer electronic component of claim 1, wherein the first and second external electrodes include a first electrode layer connected to the internal electrode, and a second electrode layer disposed on the first electrode layer, respectively, and
an average thickness of the first electrode layer is 1 μm or more and 8 μm or less.

16. The multilayer electronic component of claim 15, wherein, in the first electrode layer, a region in which a thickness is less than 1 μm is less than 5%.

17. A multilayer electronic component comprising:
a body including a capacitance forming portion and having first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and
first and second side margin portions disposed respectively on the fifth and sixth surfaces, extending to a portion of the first surface and a portion of the second surface, and each comprising a first margin layer in contact with the body and a second margin layer disposed on the first margin layer,
wherein the first and second side margin portions are disposed to extend to a portion of the third surface and a portion of the fourth surface, and
wherein the first and second margin layers are different with a boundary surface therebetween distinguishing the first and second margin layers as different layers.

18. The multilayer electronic component of claim 17, wherein the first margin layer includes a higher number of moles of gallium relative to 100 moles of titanium than that in the second margin layer.

19. The multilayer electronic component of claim 17, wherein the first margin layer includes a higher number of moles of phosphorus relative to 100 moles of titanium than that in the second margin layer.

20. The multilayer electronic component of claim 17, wherein the second margin layer includes a higher number of moles of zirconium relative to 100 moles of titanium than that in the first margin layer.

21. The multilayer electronic component of claim 17, further comprising a first external electrode disposed on the third surface of the body and a second external electrode disposed on the fourth surface of the body.

22. A multilayer electronic component comprising:
a body including a capacitance forming portion and having first and second surfaces opposing each other in the thickness direction, third and fourth surfaces connected to the first and second surfaces and opposing each other in a length direction, and fifth and sixth surfaces connected to the first to fourth surfaces and opposing each other in a width direction; and
first and second side margin portions disposed respectively on the fifth and sixth surfaces, extending to a portion of the first surface and a portion of the second surface, and each comprising a first margin layer in contact with the body and a second margin layer disposed on the first margin layer,
wherein an average size of the grains in the first margin layer is greater than an average size of the grains in the second margin layer, and
wherein the first and second side margin portions disposed on the portions of the first and second surfaces include a substantially concave region respectively towards the fifth and sixth surfaces.

23. The multilayer electronic component of claim 22, wherein a radius of curvature R1 of the substantially concave region of each of the first and second side margin portions disposed on the portion of the first surface and the portion of the second surface satisfies 500 μm≤R1≤700 μm.

24. The multilayer electronic component of claim 22, wherein the first and second side margin portions are disposed to extend to a portion of the third surface and a portion of the fourth surface.

25. The multilayer electronic component of claim 24, wherein a radius of curvature R2 of the substantially concave region of each of the first and second side margin portions disposed on the third and fourth surfaces satisfies 1000 μm≤R2≤1200 μm.
